(19) United States
(12) Patent Application Publication
(10) Pub. No.: US 2011/0317007 A1
(43) Pub. Date: Dec. 29, 2011

(54) SMOKE AND CARBON MONOXIDE ALARM DEVICE HAVING A VIDEO CAMERA

(76) Inventor: Ki-Il KIM, Los Angeles, CA (US)

(21) Appl. No.: 12/823,110

(22) Filed: Jun. 24, 2010

(51) Int. Cl. G08B 17/10; H04N 7/18

(52) U.S. Cl. 348/143; 340/628; 340/632; 348/E07.085

(57) ABSTRACT

The present invention relates to a smoke and carbon monoxide alarm system including a smoke and carbon monoxide alarm device and a base unit connected to the smoke and carbon monoxide alarm device through at least one of wire connection or wireless connection. The smoke and carbon monoxide alarm device can include a control circuit configured to receive an input signal and transmit an alarm signal; a first sensor coupled to the control circuit, the first sensor being configured to generate the input signal upon detecting smoke; a second sensor coupled to the control circuit, the second sensor being configured to generate the input signal upon detecting carbon monoxide; and a camera coupled to the control circuit, the camera being configured to be activated by the control circuit when the alarm signal is transmitted to an alarm. The base unit can include a cellular transceiver configured to transmit images captured by the camera to a pre-determined remote station.

### BACKGROUND OF THE DISCLOSURE

1. Field of the Disclosure

The present invention relates to a smoke and carbon monoxide detector configured to detect the presence of smoke or carbon monoxide in the environment and to activate a video camera located in the housing of the smoke and carbon monoxide detector upon activating an alarm. In particular, the present invention provides a smoke and carbon monoxide detector integrated with cellular or satellite phone functionality to transmit images captured by the video camera to a remote station such as a 911 emergency call station.

2. Discussion of Background Information

A smoke detector is a device that detects smoke, typically as an indicator of fire. The United States requires smoke detectors on every habitable level and within the vicinity of all bedrooms. Habitable levels include attics that are tall enough to allow access.

Carbon monoxide (CO), also called carbonic oxide, is a colorless, odorless and tasteless gas which is lighter than air. It is highly toxic to humans and animals in higher quantities, although it is also produced in normal animal metabolism in low quantities, and is thought to have some normal biological functions.

Carbon monoxide is produced from the partial oxidation of carbon-containing compounds and it forms when there is not enough oxygen to produce carbon dioxide (CO₂), such as when operating a stove or an internal combustion engine in an enclosed space. Carbon monoxide burns with a blue flame, producing carbon dioxide. Coal gas, which was widely used before the 1960s for domestic lighting, cooking and heating despite its toxicity, had carbon monoxide as a primary constituent. Some processes in modern technology, such as iron smelting, still produce carbon monoxide as a byproduct.

Carbon monoxide poisoning is the leading cause of accidental poisoning death in the United States. High concentrations of CO-a colorless, odorless gas that is produced when fossil fuel is incompletely burned-can cause cognitive impairment, loss of consciousness, coma, and often death. Carbon monoxide detection and notification devices installed in residential and other dwellings provide an effective way to reduce the incidence of CO poisoning. Thus, in twenty six states of the United States of America, installation of CO detection and notification devices in dwellings is required by law. California enacted the Carbon Monoxide Poisoning Prevention Act of 2010 (SB 183) on May 7, 2010.

Devices for sensing dangerous levels of carbon monoxide and initiating an alarm are presently available. For example, U.S. Pat. No. 7,319,403 to Woodard et al. (hereinafter as “Woodard”) discloses a carbon monoxide alarm device having a cellular transceiver and method for automatically reporting and determining the geographic location of potential carbon monoxide emergencies utilizing wireless E-911 location system. However, Woodard's carbon monoxide alarm device is not provided with a video camera configured to capture real time images and a base unit of a home security monitoring system, the base unit being configured to receive the captured images from the alarm device and to transmit the captured images through a telephone, cellphone, or satellite network to a remote station.

Additionally, U.S. Pat. Nos. 6,681,120, and 7,321,783 disclose a mobile entertainment and communications device having a video camera and a sensor for detecting one of motion, light, heat, smoke, carbon monoxide and poisonous gas. However, the mobile entertainment and communications device is not designed to be used as a smoke and carbon monoxide detector configured to be installed inside buildings. Moreover, the mobile entertainment and communications device is not integrated with the home security system.

In a conventional home security system, closed-circuit television (CCTV) cameras are installed separately from smoke alarm devices such that installing such conventional home security system can be cost prohibitive. Additionally, these CCTV cameras should be provided with AC power wires through holes on the wall and may be easily accessible by intruders such that the intruder can cut off the wires to disconnect the CCTV cameras.

### SUMMARY OF THE DISCLOSURE

Thus, according to one aspect of the present invention, there is provided a smoke and carbon monoxide detector having a video camera and a microphone, the smoke and carbon monoxide detector being configured to be installed inside a building and being equipped with a cellphone or satellite phone functionality to transmit data captured by the video camera and the microphone to a remote station such as a 911 emergency call station, a remote commercial central station monitoring the building, the owner of the building, etc.

According to another aspect of the present invention, there is provided a smoke and carbon monoxide alarm system integrated with a home security system, the smoke and carbon monoxide alarm system being connected to a base unit of the home security system through wire connection or wireless connection to transmit data captured by the camera and microphone to the base unit having a cellphone or satellite phone functionality through which the data is transmitted to a 911 station or a remote commercial central station monitoring facility.

In accordance with one or more aspects of the present invention, a smoke alarm device is provided that can include: a control circuit configured to receive an input signal and transmit an alarm signal; a sensor coupled to the control circuit, the sensor being configured to generate the input signal upon detecting smoke; and a camera coupled to the control circuit, the camera being configured to be activated by the control circuit when the alarm signal is transmitted to an alarm.

In accordance with one or more embodiments of the present invention, the smoke alarm device can include a microphone configured to capture sounds, and to be activated by the control circuit when the alarm signal is transmitted to the alarm.

In accordance with one or more embodiments of the present invention, the smoke alarm device can include a cellular transceiver configured to transmit images captured by the camera and sounds captured by the microphone to a pre-determined remote station.

In accordance with one or more embodiments of the present invention, the smoke alarm device can include a satellite phone transceiver configured to transmit images captured by the camera and sounds captured by the microphone to a pre-determined remote station.

In accordance with one or more embodiments of the present invention, the smoke alarm device can include a night vision camera.

In accordance with one or more embodiments of the present invention, the smoke alarm device can include an internal memory and a socket configured to receive a replaceable memory card.

In accordance with one or more embodiments of the present invention, the smoke alarm device can include at least one of, a motion sensor, a sound sensor, a light sensor, a carbon sensor, or any combination thereof.

In accordance with one or more embodiments of the present invention, the smoke alarm device can include a jack configured to connect the smoke alarm device to an outside electronic device.

In accordance with one or more aspects of the present invention, a carbon monoxide alarm device is provided that can include: a control circuit configured to receive an input signal and transmit an alarm signal; a sensor coupled to the control circuit, the sensor being configured to generate the input signal upon detecting carbon monoxide; and a camera coupled to the control circuit, the camera being configured to be activated by the control circuit when the alarm signal is transmitted to an alarm.

In accordance with one or more embodiments of the present invention, the carbon monoxide alarm device can include a microphone configured to capture sounds, the microphone being configured to be activated by the control circuit when the alarm signal is transmitted to the alarm.

In accordance with one or more embodiments of the present invention, the carbon monoxide alarm device can include a cellular transceiver configured to transmit images captured by the camera and sounds captured by the microphone to a pre-determined remote station.

In accordance with one or more embodiments of the present invention, the carbon monoxide alarm device can include a satellite phone transceiver configured to transmit images captured by the camera and sounds captured by the microphone to a pre-determined remote station.

In accordance with one or more embodiments of the present invention, the carbon monoxide alarm device can include a night vision camera.

In accordance with one or more embodiments of the present invention, the carbon monoxide alarm device can include an internal memory and a socket configured to receive a replaceable memory card.

In accordance with one or more embodiments of the present invention, the carbon monoxide alarm device can include at least one of, a motion sensor, a sound sensor, a light sensor, a smoke sensor, or any combination thereof.

In accordance with one or more embodiments of the present invention, the carbon monoxide alarm device can include a jack configured to connect the carbon monoxide alarm device to an outside electronic device.

In accordance with one or more aspects of the present invention, a smoke and carbon monoxide alarm device is provided that can include: a control circuit configured to receive an input signal and transmit an alarm signal; a first sensor coupled to the control circuit, the first sensor being configured to generate the input signal upon detecting smoke; a second sensor coupled to the control circuit, the second sensor being configured to generate the input signal upon detecting carbon monoxide; and a camera coupled to the control circuit, the camera being configured to be activated by the control circuit when the alarm signal is transmitted to an alarm.

In accordance with one or more embodiments of the present invention, the smoke and carbon monoxide alarm device can include a microphone configured to capture sounds, the microphone being configured to be activated by the control circuit when the alarm signal is transmitted to the alarm.

In accordance with one or more embodiments of the present invention, the smoke and carbon monoxide alarm device can include a cellular transceiver configured to transmit images captured by the camera and sounds captured by the microphone to a pre-determined remote station.

In accordance with one or more embodiments of the present invention, the smoke and carbon monoxide alarm device can include a satellite phone transceiver configured to transmit images captured by the camera and sounds captured by the microphone to a pre-determined remote station.

In accordance with one or more embodiments of the present invention, the smoke and carbon monoxide alarm device can include a night vision camera.

In accordance with one or more embodiments of the present invention, the smoke and carbon monoxide alarm device can include an internal memory and a socket configured to receive a replaceable memory card.

In accordance with one or more embodiments of the present invention, the smoke and carbon monoxide alarm device can include at least one of, a motion sensor, a sound sensor, a light sensor, a smoke sensor, or any combination thereof.

In accordance with one or more embodiments of the present invention, the smoke and carbon monoxide alarm device can include a jack configured to connect the smoke and carbon monoxide alarm device to an outside electronic device.

In accordance with one or more aspects of the present invention, a smoke and carbon monoxide alarm system is provided that can include: a smoke and carbon monoxide alarm device including a control circuit configured to receive an input signal and transmit an alarm signal; a first sensor coupled to the control circuit, the first sensor being configured to generate the input signal upon detecting smoke; a second sensor coupled to the control circuit, the second sensor being configured to generate the input signal upon detecting carbon monoxide; and a camera coupled to the control circuit, the camera being configured to be activated by the control circuit when the alarm signal is transmitted to an alarm; and a base unit connected to the smoke and carbon monoxide alarm device through at least one of, a wire connection or a wireless connection, the base unit including a cellular transceiver configured to transmit images captured by the camera to a pre-determined remote station.

In accordance with one or more embodiments of the present invention, the smoke and carbon monoxide alarm system can include a microphone configured to capture sounds, the microphone being configured to be activated by the control circuit when the alarm signal is transmitted to the alarm.

In accordance with one or more embodiments of the present invention, the smoke and carbon monoxide alarm system can include a night vision camera.

In accordance with one or more embodiments of the present invention, the smoke and carbon monoxide alarm system can include an internal memory and a socket configured to receive a replaceable memory card.

In accordance with one or more embodiments of the present invention, the smoke and carbon monoxide alarm system can include a base unit configured to store images captured by the camera to at least one of the internal memory and the replaceable memory card.

In accordance with one or more embodiments of the present invention, the smoke and carbon monoxide alarm system can include the smoke and carbon monoxide alarm device including at least one of, a motion sensor, a sound sensor, a light sensor, or any combination thereof.

In accordance with one or more embodiments of the present invention, the smoke and carbon monoxide alarm system can include the base unit including a jack configured to connect the base unit to an outside electronic device.

### BRIEF DESCRIPTION OF THE DRAWINGS

These and other features, aspects and advantages of the present invention will become better understood with regard to the following description, appended claims, and accompanying drawings, where:

FIG. 1 shows a plan view of a smoke alarm device having a video camera in accordance to one or more embodiments of the present invention, illustrating components of the device;

FIG. 2 shows a plan view of a carbon monoxide alarm device having a video camera in accordance with one or more embodiments of the present invention, illustrating components of the device;

FIG. 3 shows a plan view of a smoke and carbon monoxide alarm device in accordance with one or more embodiments of the present invention, illustrating components of the device;

FIG. 4 shows a plan view of a base unit of a home security system in accordance with one or more embodiments of the present invention, illustrating components of the unit; and

FIG. 5 shows a schematic drawing of the components of the smoke and/or carbon monoxide alarm device/system shown in FIGS. 1-4.

### DETAILED DESCRIPTION OF PREFERRED EMBODIMENTS

Prior to describing the details of the present invention in its illustrative embodiments, it should be understood that this invention is not limited in its application or use to the arrangement of parts and details of construction shown in the attached drawings, due to the fact that the illustrative embodiments may be incorporated in other embodiments or variations, and may be modified or implemented in other ways. Additionally, any technical terms or expressions used herein are for the purpose of describing the illustrative embodiments, and not for limiting the scope of the invention.

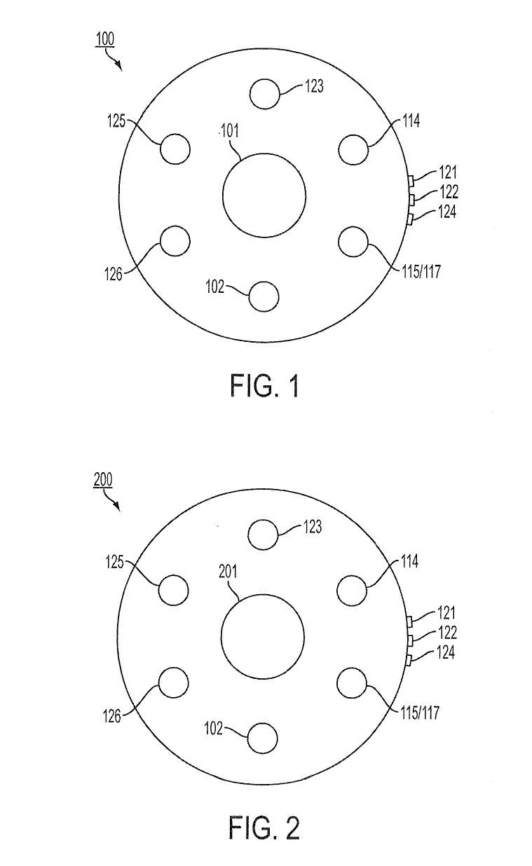

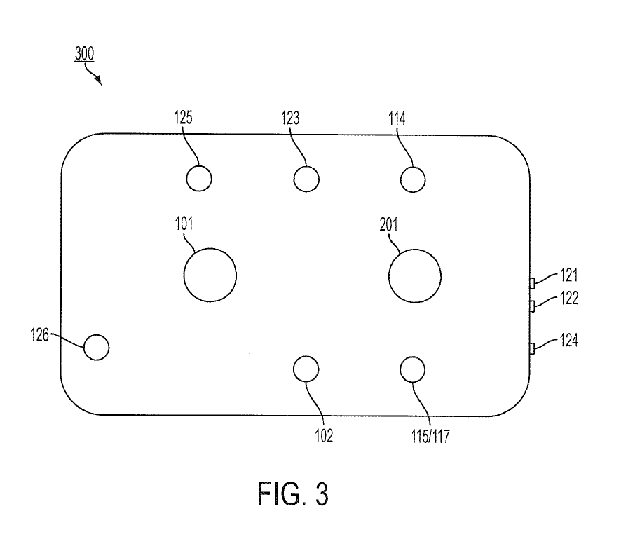

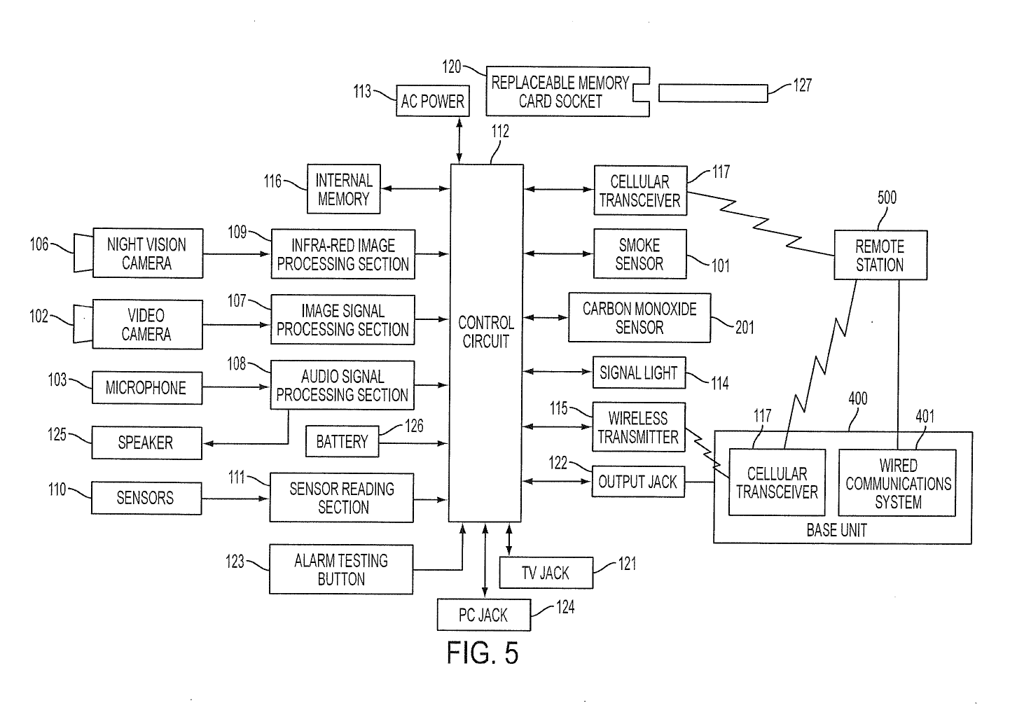

Referring more particularly to FIGS. 1-5, in one embodiment of the present invention, a smoke alarm device 100 (as shown in FIG. 1) can include a control circuit 112 (shown in FIG. 5) and a smoke sensor 101 configured to detect smoke, the smoke sensor 101 being operatively connected to the control circuit 112. In another embodiment of the present invention, a carbon monoxide alarm device 200 (as shown in FIG. 2) can include the control circuit 112 (shown in FIG. 5) and a carbon monoxide sensor 201 configured to detect the presence of carbon monoxide, the carbon monoxide sensor 201 being operatively connected to the control circuit 112. In another embodiment of the present invention, a smoke and carbon monoxide alarm device 300 (as shown in FIG. 3) can include the control circuit 112 (shown in FIG. 5), and a smoke sensor 101 and a carbon monoxide sensor 201, the smoke sensor 101 and the carbon monoxide sensor 201 being operatively connected to the control circuit 112. The control circuit 112 can receive an input signal generated from the smoke sensor 101 or carbon monoxide sensor 201 upon detecting a threshold level of smoke or carbon monoxide in a house and can transmit an alarm signal to activate an electronic buzzer or alarm speaker 125 capable of generating alarm sounds between 80 and 120 db. The smoke alarm device 100, carbon monoxide alarm device 200, and smoke and carbon monoxide alarm device 300 can include a video (image) camera 102 configured to capture images, an image signal processing section 107 configured to process the captured images to store to an internal memory 116, a microphone 103 configured to capture sounds, and an audio signal processing section 108 configured to store the captured sounds to the internal memory 116 (as shown in FIG. 5). The video camera 102 and the microphone 103 can be activated by the control circuit 112 when the alarm signal is transmitted to the electronic buzzer or alarm speaker 125. For example, the video camera 102 can be a CCD or CMOS digital camera.

These devices 100, 200, 300 can include a cellular or satellite transceiver 117 configured to transmit the captured images and sounds to a pre-determined remote station 500, such as a 911 emergency call station and a central station of a commercial home security company monitoring the house.

Additionally, these devices 100, 200, 300 can include a night vision camera 106 coupled to an infra-red image processing section 109, the night vision camera configured to capture images in darkness, an internal memory 116, and a replaceable memory socket 120 configured to receive a replaceable memory card 127. The images and sounds captured by the video camera 102 and the microphone 103 can be stored to the internal memory 116 or the replaceable memory card 127.

Further, these devices 100, 200, 300 can include additional sensors 110 configured to detect one of, motion, sound, light, or any combination thereof and a sensor reading section 111 for these additional sensors 110. These devices 100, 200, 300 can include a TV jack 121 configured to connect the devices to a TV and a PC jack 124 configured to connect the devices to a personal computer such that the captured images and sounds stored in the internal memory 116 or the replaceable memory card 127 can be downloaded to outside electronic devices such as a TV and a computer. These devices 100, 200, 300 can be operated by AC power 113, but includes a battery backup 126. Further, these devices 100, 200, 300 can include an alarm testing button 123 and a red signal light 114 visibly blinking every one or five minute intervals. The interval of the red signal light can be adjustable.

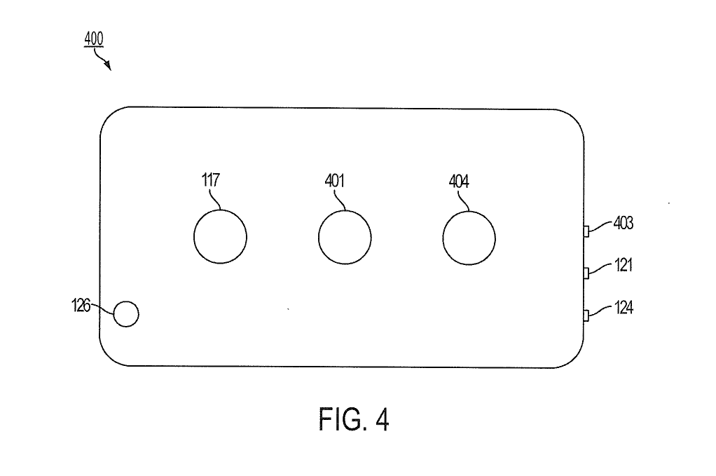

In another embodiment of the present invention, instead of the cellular or satellite transceiver 117, these devices 100, 200, 300 can include an output jack 122 connecting them to a base unit 400 (as shown in FIG. 4) of a commercially available home security system through wire connection, the base unit 400 having an input jack 403 for the wire connection with the output jack 122, such that the captured images and sounds can be transmitted to the base unit 400 having the cellular or satellite transceiver 117. Thus, the transmitted images and sounds through the wire connection can be wirelessly transmitted to the remote station 500 through the cellular or satellite transceiver 117 of the base unit 400. Also, the images and sounds transmitted from theses devices to the base unit 400 can be stored to a memory device 404 of the base unit 400.

In the alternative, these devices 100, 200, 300 can include a wireless transmitter 115 such that the captured images and sounds can be wirelessly transmitted from the transmitter 115 of these devices to the cellular or satellite transceiver 117 of the base unit 400 to store the images and sounds to the memory device 400 or to transmit the images and sounds to the remote station 500. Additionally, the base unit 400 can include a wired communications system 401 such as a telephone system such that the captured sounds and sounds can be transmitted to the remote station 500 through the wired communications system. Also, the base unit 400 can include the TV jack 121 and the PC jack 124 configured to connect it to TV and a computer to transmit data to such external devices.

What has been described are only some examples of a smoke or carbon monoxide detector systems and method for making the smoke or carbon monoxide detector systems according to preferred embodiments of the present invention. Accordingly, it is to be understood that various and numerous other arrangements may be devised by one skilled in the art without departing from the spirit and scope of the present invention as limited only by the accompanying claims.

What is claimed is:

1. A smoke alarm device, comprising:
a control circuit configured to receive an input signal and transmit an alarm signal;
a sensor coupled to the control circuit, the sensor being configured to generate the input signal upon detecting smoke; and
a camera coupled to the control circuit, the camera being configured to be activated by the control circuit when the alarm signal is transmitted to an alarm.

2. The smoke alarm device of claim 1, further comprising a microphone configured to capture sounds and to be activated by the control circuit when the alarm signal is transmitted to the alarm.

3. The smoke alarm device of claim 2, further comprising a cellular transceiver configured to transmit images captured by the camera and sounds captured by the microphone to a pre-determined remote station.

4. The smoke alarm device of claim 2, further comprising a satellite phone transceiver configured to transmit images captured by the camera and sounds captured by the microphone to a pre-determined remote station.

5. The smoke alarm device of claim 1, wherein the camera is a night vision camera.

6. The smoke alarm device of claim 1, further comprising an internal memory and a socket configured to receive a replaceable memory card.

7. The smoke alarm device of claim 1, further comprising at least one of, a motion sensor, a sound sensor, a light sensor, a carbon sensor, or any combination thereof.

8. The smoke alarm device of claim 1, further comprising a jack configured to connect the smoke alarm device to an outside electronic device.

9. A carbon monoxide alarm device, comprising:
a control circuit configured to receive an input signal and transmit an alarm signal;
a sensor coupled to the control circuit, the sensor being configured to generate the input signal upon detecting carbon monoxide; and
a camera coupled to the control circuit, the camera being configured to be activated by the control circuit when the alarm signal is transmitted to an alarm.

10. The carbon monoxide alarm device of claim 9, further comprising a microphone configured to capture sounds and to be activated by the control circuit when the alarm signal is transmitted to the alarm.

11. The carbon monoxide alarm device of claim 10, further comprising a cellular transceiver configured to transmit images captured by the camera and sounds captured by the microphone to a pre-determined remote station.

12. The carbon monoxide alarm device of claim 10, further comprising a satellite phone transceiver configured to transmit images captured by the camera and sounds captured by the microphone to a pre-determined remote station.

13. The carbon monoxide alarm device of claim 9, wherein the camera is a night vision camera.

14. The carbon monoxide alarm device of claim 9, further comprising an internal memory and a socket configured to receive a replaceable memory card.

15. The carbon monoxide alarm device of claim 9, further comprising at least one of, a motion sensor, a sound sensor, a light sensor, a smoke sensor, or any combination thereof.

16. The carbon monoxide alarm device of claim 9, further comprising a jack configured to connect the carbon monoxide alarm device to an outside electronic device.

17. A smoke and carbon monoxide alarm device, comprising:
a control circuit configured to receive an input signal and transmit an alarm signal;
a first sensor coupled to the control circuit, the first sensor being configured to generate the input signal upon detecting smoke;
a second sensor coupled to the control circuit, the second sensor being configured to generate the input signal upon detecting carbon monoxide; and
a camera coupled to the control circuit, the camera being configured to be activated by the control circuit when the alarm signal is transmitted to an alarm.

18. The smoke and carbon monoxide alarm device of claim 17, further comprising a microphone configured to capture sounds and to be activated by the control circuit when the alarm signal is transmitted to the alarm.

19. The smoke and carbon monoxide alarm device of claim 18, further comprising a cellular transceiver configured to transmit images captured by the camera and sounds captured by the microphone to a pre-determined remote station.

20. The smoke and carbon monoxide alarm device of claim 18, further comprising a satellite phone transceiver configured to transmit images captured by the camera and sounds captured by the microphone to a pre-determined remote station.

21. The smoke and carbon monoxide alarm device of claim 17, wherein the camera is a night vision camera.

22. The smoke and carbon monoxide alarm device of claim 17, further comprising an internal memory and a socket configured to receive a replaceable memory card.

23. The smoke and carbon monoxide alarm device of claim 17, further comprising at least one of, a motion sensor, a sound sensor, a light sensor, a smoke sensor, or any combination thereof.

24. The smoke and carbon monoxide device of claim 17, further comprising a jack configured to connect the smoke and carbon monoxide alarm device to an outside electronic device.

25. A smoke and carbon monoxide alarm system, comprising:
a) a smoke and carbon monoxide alarm device comprising:
a1) a control circuit configured to receive an input signal and transmit an alarm signal;
a2) a first sensor coupled to the control circuit, the first sensor being configured to generate the input signal upon detecting smoke;
a3) a second sensor coupled to the control circuit, the second sensor being configured to generate the input signal upon detecting carbon monoxide; and
a4) a camera coupled to the control circuit, the camera being configured to be activated by the control circuit when the alarm signal is transmitted to an alarm; and
b) a base unit connected to the smoke and carbon monoxide alarm device through at least one of wire connection or wireless connection, the base unit comprising:
b1) a cellular transceiver configured to transmit images captured by the camera to a pre-determined remote station.

26. The smoke and carbon monoxide alarm system of claim 25, wherein the smoke and carbon monoxide alarm device further comprises:
a5) a microphone configured to capture sounds and to be activated by the control circuit when the alarm signal is transmitted to the alarm.

27. The smoke and carbon monoxide alarm system of claim 25, wherein the camera is a night vision camera.

28. The smoke and carbon monoxide alarm system of claim 25, wherein the base unit further comprises:
b2) an internal memory and a socket configured to receive a replaceable memory card.

29. The smoke and carbon monoxide alarm system of claim 28, wherein the base unit is configured to store images captured by the camera to at least one of, the internal memory and the replaceable memory card.

30. The smoke and carbon monoxide alarm system of claim 25, wherein the smoke and carbon monoxide alarm device further comprises:
a5) at least one of, a motion sensor, a sound sensor, a light sensor, or any combination thereof.

31. The smoke and carbon monoxide alarm system of claim 25, wherein the base unit further comprises:
b2) a jack configured to connect the base unit to an outside electronic device.

32. A smoke and carbon monoxide alarm system, comprising:
a) a smoke and carbon monoxide alarm device comprising:
a1) a control circuit configured to receive an input signal and transmit an alarm signal;
a2) a first sensor coupled to the control circuit, the first sensor being configured to generate the input signal upon detecting smoke;
a3) a second sensor coupled to the control circuit, the second sensor being configured to generate the input signal upon detecting carbon monoxide; and
a4) a night vision camera coupled to the control circuit, the camera being configured to be activated by the control circuit when the alarm signal is transmitted to an alarm;
a5) a microphone configured to capture sounds and to be activated by the control circuit when the alarm signal is transmitted to the alarm;
a6) at least one of, a motion sensor, a sound sensor, a light sensor, or any combination thereof; and
b) a base unit connected to the smoke and carbon monoxide alarm device through at least one of wire connection or wireless connection, the base unit comprising:
b1) a cellular transceiver configured to transmit images captured by the camera to a pre-determined remote station; and
b2) an internal memory and a socket configured to receive a replaceable memory card; and
b3) a jack configured to connect the base unit to an outside electronic device, and wherein the base unit is configured to store images captured by the camera to at least one of, the internal memory and the replaceable memory card.
